(19) United States
(12) Patent Application Publication
(10) Pub. No.: US 2008/0101265 A1
(43) Pub. Date: May 1, 2008

(54) INFORMATION PROCESSOR AND COMMUNICATION CONTROL METHOD FOR INFORMATION PROCESSOR

(75) Inventors: Kenichi TONOUCHI, Tokyo (JP); Yoshinori HONDA, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/774,126

(22) Filed: Jul. 6, 2007

(30) Foreign Application Priority Data
Oct. 26, 2006 (JP) 2006-291405

(51) Int. Cl. H04Q 7/00

(52) U.S. Cl. 370/310

(57) ABSTRACT

An information processor comprising: a management unit that manages attribute information respectively corresponding to a plurality of communication tasks for performing a communication through at least one of a plurality of communication modules; and a control unit that dynamically controls allocation of the plurality of communication tasks to the plurality of communication modules in accordance with the attribute information.

### CROSS-REFERENCE TO RELATED APPLICATIONS

This application is based upon and claims the benefit of priority from Japanese Patent Application No. 2006-291405, filed Oct. 26, 2006, the entire contents of which are incorporated herein by reference.

### BACKGROUND

1. Field

One embodiment of the present invention relates to a communication control technique preferably applied to an information processor, for instance, a personal computer.

2. Description of the Related Art

In recent years, a radio communication in which a cable does not need to be laid has been used in various scenes in place of a wired communication that has been hitherto mainly used. With the propagation of the radio communication, various methods for efficiently establishing a radio communication path has been proposed (for instance, see JP-A-2004-48152 or the like).

This radio communication begins to be employed for a connection to a keyboard or a mouse as well as a data communication with other electronic devices. Further, most of personal computers of a notebook type have a plurality of connectors for expanding functions, and can increase radio communication modules as required. Accordingly, a plurality of radio communication modules can be mounted thereon.

In a communication using Ethernet® as the standard of the wired communication that employs a coaxial cable, since it is not anticipated that the cable is dynamically increased or decreased, an absolutely physical communication path is ordinarily determined. However, when the radio communication modules are increased as required, it is not realistic to fixedly determine the communication path. Further, if the communication path is fixedly determined, for instance, though a communication task allocated to a certain radio communication module does not start a communication, when all communication tasks allocated to other radio communication modules start the communication, the communication load of the entire part of a system is biased to the specific radio communication modules.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of a computer according to one embodiment of the present invention;

FIG. 2 is an exemplary diagram showing a structure of a system of the computer of this embodiment;

FIG. 3 is an exemplary conceptual view showing a state of the allocation of a plurality of communication tasks to a plurality of communication modules that is carried out in the computer of this embodiment;

FIG. 4 is an exemplary diagram showing functional blocks of a Bluetooth communication control module operating on the computer of this embodiment;

FIG. 5 is an diagram showing one example of a condition table provided in the Bluetooth communication control module operating on the computer of this embodiment; and

FIG. 6 is an exemplary flowchart showing the flow of the allocating control of the communication tasks to the communication modules performed by the computer of this embodiment;

### DETAILED DESCRIPTION

Various embodiments according to the invention will be described hereinafter with reference to the accompanying drawings. In general, according to one embodiment of the invention, an information processor comprising: a management unit that manages attribute information respectively corresponding to a plurality of communication tasks for performing a communication by using at least one of a plurality of communication modules; and a control unit that dynamically controls allocation of the plurality of communication tasks to the plurality of communication modules in accordance with the attribute information.

An embodiment of the present invention will be described below by referring to the drawings. An information processor according to one embodiment of the present invention is realized by, for instance, a personal computer 10 of a notebook type.

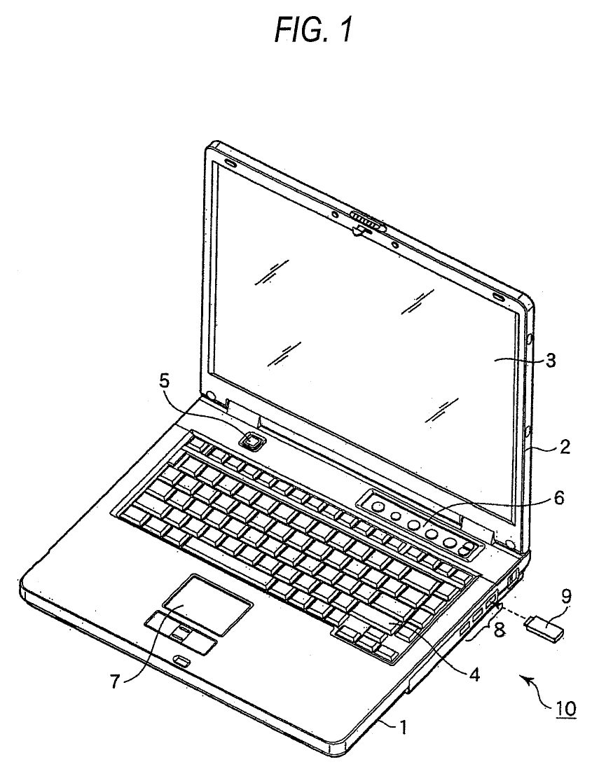

FIG. 1 is a perspective view showing a state that a display unit of the notebook type personal computer 10 is opened. This computer 10 includes a computer main body 1 and the display unit 2. In the display unit 2, a display device composed of an LCD (Liquid Crystal Display) 3 is incorporated and a display screen of the LCD 3 is located at a substantially central part of the display unit 2.

The display unit 2 is attached so as to freely rotate between an opening position and a closing position relative to the computer main body 1. The computer main body 1 has a thin box shaped casing and a keyboard 4, a power button 5 for turning on/off the computer 10, an input operating panel 6 and a touch pad 7 or the like are arranged on the upper surface of the computer main body.

Further, on the side surface of the computer main body 1, a plurality of USB (Universal Serial Bus) connectors 8 are provided so that various peripheral devices can be connected and increased. As one of the peripheral devices that can be connected to the USB connector 8, a communication module for performing a radio communication based on a short-range communication standard called a Bluetooth® is exemplified. When the number of the communication modules 9 is increased, a file can be transferred to other computer or a wireless keyboard, a wireless mouse, a wireless headset or the like can be used.

When there is a plurality of communication tasks in parallel, for instance, when the file is transferred to other computer and the wireless headset is used at the same time, in the Bluetooth, a plurality of radio communications are apparently performed in time division at the same time. Therefore, when the number of the communication tasks existing in parallel is increased, the data transfer rate of each communication task is lowered. On the other hand, since the computer 10 has a plurality of USB connectors 8, the plurality of communication modules 9 can be increased. Then, when the plurality of communication modules 9 are provided, to properly distribute a communication load, it is very important to allocate the communication tasks respectively to the communication modules 9 depending on operating states of the communication tasks in each time. Thus, the computer 10 serves to dynamically and properly allocate the plurality of communication tasks to the plurality of communication modules 9. Now, this point will be described in detail.

Here, the Bluetooth is explained as an example, however, this communication control method may be applied not only to the Bluetooth, but also to all UWB (Ultra Wide Band) for realizing a high speed short-range communication that can reallocate the communication tasks respectively to the communication modules.

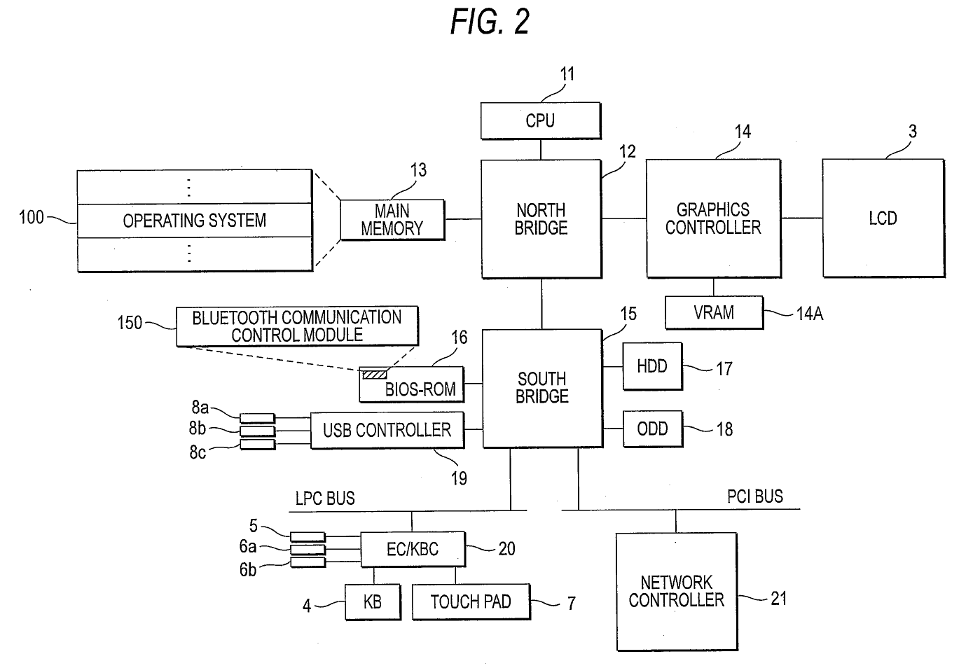

FIG. 2 is a diagram showing the structure of a system of the computer 10.

The computer 10 includes, as shown in FIG. 2, a CPU 11, a north bridge 12, a main memory 13, a graphics controller 14, a south bridge 15, a BIOS (Basic Input Output System)-ROM 16, a hard disk drive (HDD) 17, an optical disk drive (ODD) 18, a USB controller 19, an embedded controller/keyboard controller IC (EC/KBC) 20 and a network controller 21.

The CPU 11 is a processor provided for controlling the operation of the computer 10 to execute various kinds of programs including an operating system 100 loaded in the main memory 13 from the HDD drive 17. Further, the CPU 11 also executes the BIOS stored in the BIOS-ROM 16. The BIOS indicates a group of programs for controlling hardware. In one of the programs, a Bluetooth communication control module 150 is provided for performing and controlling the radio communication based on the Bluetooth standard.

The north bridge 12 is a bridge device for connecting a local bus of the CPU 11 to the south bridge 15. In the north bridge 12, a memory controller for controlling to access the main memory 13 is also incorporated. Further, the north bridge 12 also has a function for performing a communication with the graphics controller 14 through an AGP (Accelerated Graphics Port) bus.

The graphics controller 14 is a display controller for controlling the LCD 3 used as a display monitor of the computer 10. The graphics controller 14 generates a display signal to be transmitted to the LCD 3 from image data written in a video memory (VRAM) 14A.

The south bridge 15 controls the BIOS-ROM 16, the HDD 17, the ODD 18 and the USB controller 19 directly connected to devices on an LPC (Low Pin Count) bus and devices on a PCI (Peripheral Component Interconnect) bus, respectively. In the south bridge 15, an IDE (Integrated Drive Electronics) controller for controlling the HDD 17 is incorporated.

The HDD and the ODD 18 are storage devices for storing various kinds of software and various kinds of data. Further, the USB controller 19 is a control unit for performing a communication with peripheral devices connected to the USB connectors 8 (8a to 8c).

The EC/KBC 20 is a one-chip microcomputer in which an embedded controller for controlling an electric power and a keyboard controller for controlling the keyboard (KB) 4 and the touch pad 7 are integrated. The EC/KBC 20 has a function for turning on/off the computer 10 in accordance with the operation of the power button 5 by a user. The network controller 21 is a communication device for performing a communication with a LAN (Local Area Network).

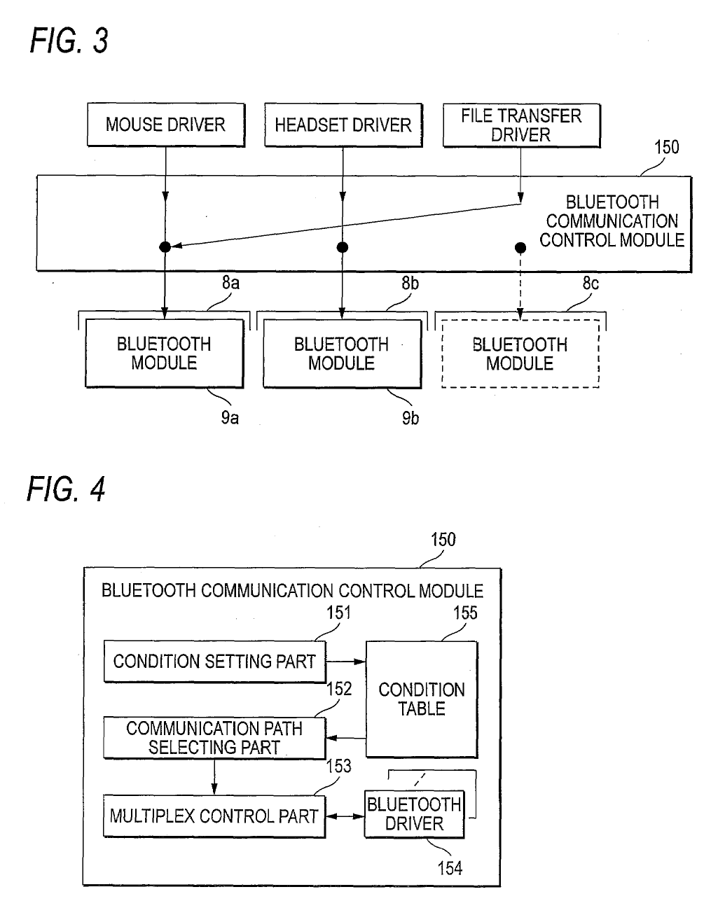

FIG. 3 is a conceptual view showing a state that the plurality of communication tasks are allocated to the plurality of communication modules (sometimes refer them to as Bluetooth modules, hereinafter) 9 in the computer 10 having the above-described structure.

Now, it is assumed that the two Bluetooth modules 9 (9a, 9b) are attached to the two USB connectors 8 (8a, 8b). Further, it is assumed that while the wireless mouse and the wireless headset are used, the transfer of the file to other computer is started.

The wireless mouse and the headset are respectively controlled through a mouse driver and a headset driver and the transfer of the file between the computer and other computer is performed through a file transfer driver. Then, the Bluetooth communication control module 150 is interposed between the mouse driver, the headset driver and the file transfer driver and the Bluetooth modules 9 to suitably select communication paths respectively. In an example shown in FIG. 3, since a communication load by using the wireless mouse is larger than a communication load by using the wireless headset, the Bluetooth communication control module 150 further allocates the communication task for transferring the file between the computer and other computer to the Bluetooth module 9a to which the communication task for using the wireless mouse (smaller in its communication load) is already allocated.

To perform such an allocation control, the Bluetooth communication control module 150 includes, as shown in FIG. 4, a condition setting part 151, a communication path selecting part 152, a multiplex control part 153, a Bluetooth driver 154 and a condition table 155.

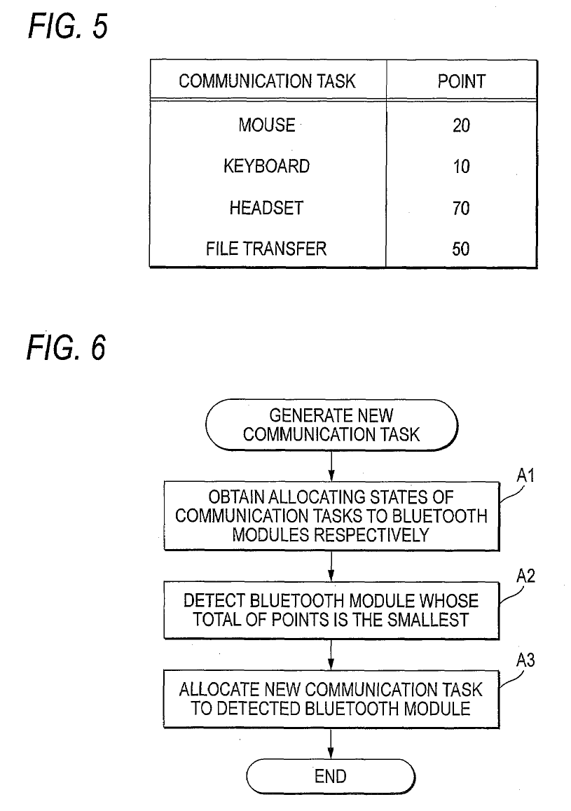

The condition setting part 151 provides a user interface for giving points respectively to the communication tasks. The point numerically represents the communication load of each communication task. The communication task having a larger communication load has the larger value. The condition setting part 151 stores the points of the communication tasks respectively inputted by a user in the condition table 155. FIG. 5 is a diagram showing one example of the points stored in the condition table 155 by the condition setting part 151. Information stored as the communication task may be any information that the Bluetooth communication control module 150 can identify, for instance, the names of the modules of the drivers such as the mouse driver or the headset driver.

The communication path selecting part 152 grasps respectively the current states of the communication load of the Bluetooth modules 9 by employing the points stored in the condition table 155 and determines a destination to which the communication task newly starting a communication is allocated. As shown in FIG. 5, the point of the communication load by using the wireless mouse is set to 20, the point of the communication load by using the wireless keyboard is set to 10, the point of the communication load by using the headset is set to 70 and the point of the communication load by transferring the file to other computer is set to 50, respectively. The communication path selecting part 152 decides by comparing the points that the communication load by using the wireless headset is larger than the communication load by using the wireless mouse (20 points<70 points) and determines to allocate the communication task for transferring the file between the computer and other computer to the Bluetooth module 9a to which the communication task for using the wireless mouse is allocated, as shown in FIG. 3.

After the allocation, the communication path selecting part 152 considers the communication load of the Bluetooth module 9a side to be 70 points (20 points+50 points) as the total of the points of the two communication tasks and continues to control subsequent allocations. That is, in this computer 10, the plurality of communication tasks are dynamically and properly allocated to the plurality of communication modules 9 only by referring to the information in the condition table 155 without requiring a complicated mechanism for monitoring and measuring actual communication states.

If the communication task for using the wireless mouse, the communication task for using the wireless headset and the communication task for transferring the file to other computer substantially simultaneously start the communication, the communication path selecting part 152 allocates the communication tasks having the large points in order to the Bluetooth modules 9. Since the communication task for using the wireless headset has 70 points that is the largest, the communication path selecting part 152 allocates this communication task either to the Bluetooth module 9a or to the to the Bluetooth module 9b. Then, at this time, since the one module to which the communication task is allocated has the 70 points and the other module has 0 point, the communication task for transferring the file to other computer of 50 points that is secondly largest is allocated to the Bluetooth module 9 of 0 point. Thus, the one module has the 70 pints and the other module has the 50 points. Accordingly, the communication task for using the wireless mouse having the smallest points is also allocated to the Bluetooth module 9 to which the communication task for transferring the file to other computer is allocated. As a result, when the three communication tasks start the communication substantially at the same time, the allocation is carried out as shown in FIG. 3.

Further, according to this procedure, when the Bluetooth module 9 is added during the operation of the computer 10, the communication load of this Bluetooth module 9 is calculated as 0 point, and when any of the communication tasks starts the communication, the communication task is preferentially allocated to this Bluetooth module 9. In other words, the addition of the Bluetooth module 9 can be also flexibly met.

The multiplex control part 153 receives the decision of the communication path selecting part 152 and multiplexes the radio communication of the plurality of communication tasks allocated to the same Bluetooth module 9 to perform the radio communication in time division. The Bluetooth driver 154 is actuated by the number of the Bluetooth modules 9 and drives and controls the Bluetooth modules 9 respectively to perform the radio communication multiplexed by the multiplex control part 153.

FIG. 6 is an exemplary flowchart showing the flow of an allocation control of the communication tasks to the communication modules performed by the computer 10.

When any of the communication tasks start the communication, the Bluetooth communication control module 150 initially obtains the allocating states of the communication tasks respectively to the Bluetooth modules 9 (step A1). Then, the Bluetooth communication control module 150 refers to the condition table 155 to detect the Bluetooth module 9 whose total of the points is the smallest at that time (step A2). Then, the Bluetooth communication control module 150 allocates the communication task that starts the communication to the detected Bluetooth module 9 (step A3).

As described above, according to this computer 10, the plurality of communication modules can be efficiently used.

As described with reference to the embodiment, there is provided the information processor and the communication control method for the information processor that efficiently employ a plurality of communication modules.

In the above-described embodiment, an example is described in which the communication tasks are allocated to the communication modules for performing the radio communication based on the Bluetooth standard. However, the communication control method of this embodiment is not limited thereto and may be applied to a communication module that performs the radio communication of any other standard than the Bluetooth standard and to a communication module that performs a wired communication.

Namely, the present invention is not directly limited to the above-described embodiment and components may be modified within a range without departing the gist in the course of a practice and embodied. Further, a plurality of components disclosed in the embodiment may be suitably combined to devise various inventions. For instance, some components may be deleted from all the components disclosed in the embodiment. Further, components in different embodiments may be suitably combined together.

What is claimed is:

1. An information processor comprising:
a management unit that manages attribute information respectively corresponding to a plurality of communication tasks for performing a communication through at least one of a plurality of communication modules; and
a control unit that dynamically controls allocation of the plurality of communication tasks to the plurality of communication modules in accordance with the attribute information.

2. The information processor according to claim 1,
wherein the plurality of communication modules performs a radio communication based on a Bluetooth standard.

3. The information processor according to claim 1,
wherein the attribute information includes values indicating respective communication loads of the plurality of communication tasks; and
the control unit allocates the plurality of communication tasks to the plurality of communication modules so that sums of the values included in the attribute information corresponding to the respective communication tasks allocated to the respective communication modules are equalized.

4. The information processor according to claim 3,
wherein the control unit allocates one of the communication tasks to one of the communication modules having a smallest sum of the values.

5. The information processor according to claim 3,
wherein the control unit allocates the communication tasks having a largest sum of the values to one of the communication modules having a smallest sum of the values.

6. The information processor according to claim 5,
wherein, when the control unit allocates one of the communication tasks to one of the communication modules, the control unit recalculates at least one of the accumulations.

7. A communication control method for an information processor having a plurality of communication modules, the method comprising:
managing attribute information respectively corresponding to a plurality of communication tasks for performing a communication through one of a plurality of communication modules; and
dynamically controlling allocation of the plurality of communication tasks to the plurality of communication modules in accordance with the managed attribute information.

8. The communication control method according to claim 7,
wherein managing values indicating respective communication loads of the plurality of communication tasks as attribute information; and
allocating the plurality of communication tasks to the plurality of communication modules so that sum of the values included in the attribute information corresponding to the respective communication tasks allocated to the respective communication modules are equalized.
